(19) United States
(12) Patent Application Publication
(10) Pub. No.: US 2023/0145441 A1
(43) Pub. Date: May 11, 2023

(54) PNEUMATIC ACTUATOR CONTROL DEVICE

(71) Applicant: Fanuc Corporation, Minamitsuru-gun, Yamanashi (JP)

(72) Inventor: Yoshinori Ochiishi, Minamitsuru-gun, Yamanashi (JP)

(73) Assignee: Fanuc Corporation, Minamitsuru-gun, Yamanashi (JP)

(21) Appl. No.: 17/918,637

(22) PCT Filed: Apr. 12, 2021
(86) PCT No.: PCT/JP2021/015206

§ 371 Date: Oct. 13, 2022

(30) Foreign Application Priority Data
Apr. 16, 2020 (JP) 2020-073677

(51) Int. Cl. F15B 13/044; G05D 16/20; G05B 19/416; F15B 19/00

(52) U.S. Cl. CPC F15B 13/044; G05D 16/2022; G05D 16/204; G05B 19/416; F15B 19/005; G05B 2219/37371; F15B 2211/405

(57) ABSTRACT

Provided is a pneumatic actuator control device including detectors that are disposed in an air supply passage leading from an air supply source to a solenoid valve or in an air exhaust passage leading from the solenoid valve, and that detect the flow volume or the pressure of the air in the air supply passage, or detect the flow volume or the pressure of the air in the air exhaust passage; and an operational state determination unit that, on the basis of data representing a change in the flow volume or the pressure of the air in the air supply passage, or in the flow volume or the pressure of the air in the air exhaust passage, as detected by the detectors, determines the operational state of a pneumatic actuator connected to the solenoid valve.

### CROSS REFERENCE TO RELATED APPLICATIONS

This is the U.S. National Phase application of PCT/JP2021/015206, filed Apr. 12, 2021, which claims priority to Japanese Patent Application No. 2020-073677, filed Apr. 16, 2020, the disclosures of these applications being incorporated herein by reference in their entireties for all purposes.

### FIELD OF THE INVENTION

The present invention relates to a pneumatic actuator controller.

### BACKGROUND OF THE INVENTION

Air cylinders are often used as pneumatic actuators for the driving of air chucks, slide tables, and the like. When using an air cylinder, it is common to attach an auto switch to the air cylinder, which confirms whether the piston rod is in a protruding position or a return position (for example, Patent Literature 1 and Patent Literature 2).

The air cylinder 10 of Patent Literature 2 is configured such that a pressure sensor 20 is further arranged in an operation chamber 12 of a cylinder 11. Regarding this configuration, Patent Literature 2 describes “In S5, it is determined whether or not the detection signal of the pressure sensor 20 matches the setting characteristic of the working pressure. When the determination of S5 is yes, the process proceeds to S6, but when the determination of S5 is no, the process proceeds to S8. In S6, failure of the position switch 19 is determined, and thereafter, the operating position of the air cylinder 10 is determined based on the detection signal of the pressure sensor 20. Specifically, the operation of the air cylinder 10 is controlled in accordance with the operating position calculated based on the detection signal of the pressure sensor 20 from the setting characteristic of the operating pressure” (paragraph 0020).

Patent Literature 3 describes, regarding a vehicle automatic door opening/closing device using an air cylinder, that “based on the air pressure detected by the pressure sensor 18 when foreign matter is caught during the closing operation of the left door 3A and the right door 3B, or when foreign matter is drawn, during the opening operation, into the door pocket in which the left door 3A and the right door 3B are housed, the control unit 17 switches the air supply/exhaust direction of the air supply/exhaust switching valve 6 and switches the opening/closing operation of the left door 3A and the right door 3B” (paragraph 0020).

### PATENT LITERATURE

[PTL 1] Japanese Unexamined Patent Publication (Kokai) No. 2012-060906
[PTL 2] Japanese Unexamined Patent Publication (Kokai) No. 2004-225767
[PTL 3] Japanese Unexamined Patent Publication (Kokai) No. 2019-138060

### SUMMARY OF THE INVENTION

In a configuration in which an auto switch is used in the operation confirmation of an air cylinder, since it is necessary to install an auto switch for each air cylinder and perform wiring, the wiring becomes more complicated as the number of air cylinders in the system increases. Furthermore, assuming that the air chuck grips workpieces of different sizes, since the closed position of the air chuck, i.e., the operation end position of the air cylinder, will be different for each workpiece, it is practically impossible to detect all of the positions by installing an auto switch.

A pneumatic actuator controller which can avoid complication of wiring and the like that may occur when such an auto switch is used is desired.

An aspect of the present disclosure provides a pneumatic actuator controller, comprising a detector which is arranged in an air supply path from an air supply source to a solenoid valve or an air exhaust path from the solenoid valve and which detects a flow rate or pressure of air in the air supply path or a flow rate or pressure of air in the air exhaust path, and an operation state judgment unit configured to judge an operation state of a pneumatic actuator connected to the solenoid valve based on data indicating change in the flow rate or pressure of air in the air supply path or the flow rate or pressure of the air in the air exhaust path detected by the detector.

According to the configuration described above, complication of wiring and the like that may occur when an auto switch is used can be avoided.

The object, features, and advantages of the present invention and other objects, features, and advantages will be further clarified from detailed descriptions of typical embodiments of the present invention illustrated in the attached drawings.

### BRIEF DESCRIPTION OF DRAWINGS

FIG. 1 is a view showing the structure of an actuator control system comprising a pneumatic actuator controller according to an embodiment.

FIG. 2 is a functional block diagram of a controller.

FIG. 3 shows flow rate and pressure waveform data obtained by a flow sensor and pressure sensor attached in an air supply path when a piston rod of an air cylinder moves from a retracted position to a forwardmost position.

FIG. 4A is a view schematically illustrating a series of movements from a state where a piston rod of an air cylinder is in a retracted position to a forwardmost position along with FIGS. 4B to 4D.

FIG. 4B is a view schematically illustrating a series of movements from a state where a piston rod of an air cylinder is in a retracted position to a forwardmost position along with FIGS. 4A, 4C, and 4D.

FIG. 4C is a view schematically illustrating a series of movements from a state where a piston rod of an air cylinder is in a retracted position to a forwardmost position along with FIGS. 4A, 4B, and 4D.

FIG. 4D is a view schematically illustrating a series of movements from a state where a piston rod of an air cylinder is in a retracted position to a forwardmost position along with FIGS. 4A to 4C.

FIG. 5 shows flow rate and pressure waveform data obtained by a flow sensor and a pressure sensor attached in an air exhaust path when a piston rod of an air cylinder moves from a retracted position to a forwardmost position.

FIG. 6 is a flowchart showing an air cylinder control process in the case in which one air cylinder moves.

FIG. 7 is a view showing waveform data in the case in which a first of three air cylinders moves.

FIG. 8 is a view showing waveform data in the case in which a second of three air cylinders moves.

FIG. 9 is a view showing waveform data in the case in which a third of three air cylinders moves.

FIG. 10 is a view showing composite waveform data in the case in which three air cylinders move.

FIG. 11 is a flowchart showing an air cylinder control process in the case in which three air cylinders move.

### DETAILED DESCRIPTION OF EMBODIMENTS OF THE INVENTION

Next, the embodiments of the present disclosure will be described with reference to the drawings. In the referenced drawings, identical constituent portions of functional portions are assigned the same reference sign. In order to facilitate understanding, the scales of the drawings have been appropriately changed. Furthermore, the aspects shown in the drawings are merely examples for carrying out the present invention, and the present invention is not limited to the illustrated aspects.

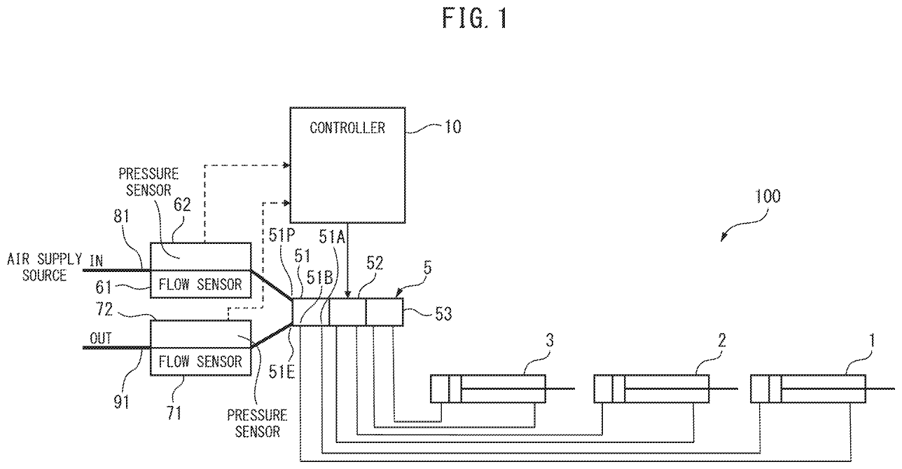

FIG. 1 is a view showing the structure of an actuator control system 100 comprising a pneumatic actuator controller 10 according to an embodiment. As shown in FIG. 1, the actuator control system 100 comprises three air cylinders 1 to 3, solenoid valves 51 to 53 which perform the respective opening/closing control of air to be supplied to the air cylinders 1 to 3, and a controller 10 which controls the solenoid valves 51 to 53. The air cylinders 1 to 3 are double-acting air cylinders in the present embodiment. Each of the solenoid valves 51 to 53 is a four-way solenoid valve having, for example, one supply port, two cylinder ports, and one exhaust port. In FIG. 1, representatively, the supply port, two cylinder ports, and exhaust port of the solenoid valve 51 have been assigned the reference signs 51P, 51A, 51B, and 51E, respectively. The supply port of each of the solenoid valves 51 to 53 is commonly connected to an air supply path 81, for example, formed of an air hose from an air supply source. The exhaust port of each of the solenoid valves 51 to 53 is commonly connected to an air exhaust path 91, for example, formed of an air hose. Below, for convenience of explanation, the solenoid valves 51 to 53 may be collectively referred to as the solenoid valve 5.

Each of the solenoid valves 51 to 53 is electrically connected to the controller 10, and each of the solenoid valves 51 to 53 operates in accordance with operation commands from the controller. The types of air cylinders 1 to 3 and solenoid valves 51 to 53 shown here are exemplary, and other types of air cylinders (for example, single-acting air cylinders) and other types of solenoid valves (for example, three-way solenoid valves) may be used.

As shown in FIG. 1, a flow sensor 61 which detects the flow rate of air flowing in the air supply path 81 and a pressure sensor 62 which detects the pressure of air in the air supply path 81 are arranged in the air supply path 81 from the air supply source to the solenoid valve 5. Furthermore, a flow sensor 71 which detects the flow rate of air flowing in the air exhaust path 91 and a pressure sensor 72 which detects the pressure of air in the air exhaust path 91 are arranged in the air exhaust path 91 which guides exhaust from the solenoid valve 5. Note that though a configuration example of the case in which there are three air cylinders is illustrated in FIG. 1, the number of air cylinders may be 1, or may be a plurality of air cylinders other than three.

The controller 10 can control each of the solenoid valves 51 to 53 by transmitting electrical signals as operation commands to the solenoid valves 51 to 53. Note that the controller 10 may have a structure as a general computer comprising a CPU, ROM, RAM, a storage device, operation units, a display unit, an input/output interface, a networking interface, etc.

The air cylinders 1 to 3 drive, for example, a gripping device (chuck) equipped on a robot device. In this case, the actuator control system 100 functions as a system which performs opening/closing control of the gripping device equipped on the robot device in accordance with commands from a host device (robot controller).

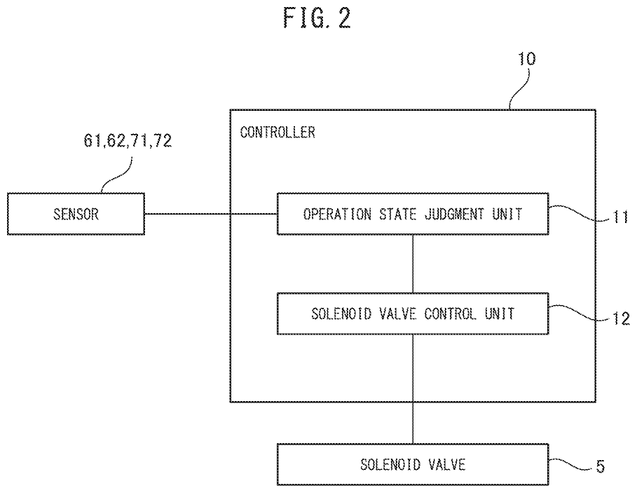

As shown in FIG. 2, the controller 10 comprises an operation state judgment unit 11 which judges the operation states of the air cylinders 1 to 3 based on any of the flow rate detected by the flow sensor 61, the pressure detected by the pressure sensor 62, the flow rate detected by the flow sensor 71, and the pressure detected by the pressure sensor 72, and a solenoid valve control unit 12 which executes control of the air cylinders 1 to 3 based on the operation states of the air cylinders 1 to 3 judged by the operation state judgment unit 11.

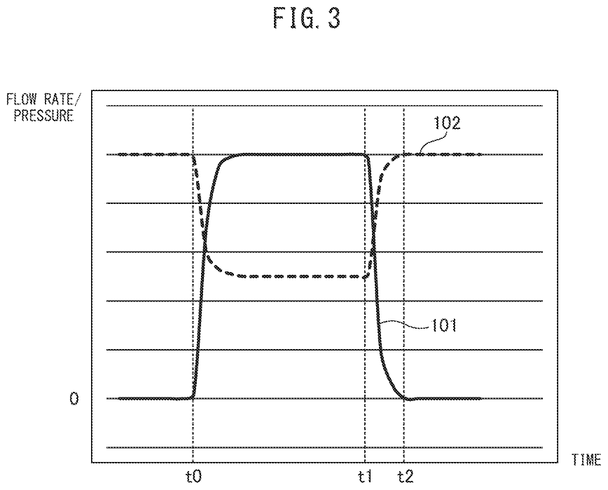

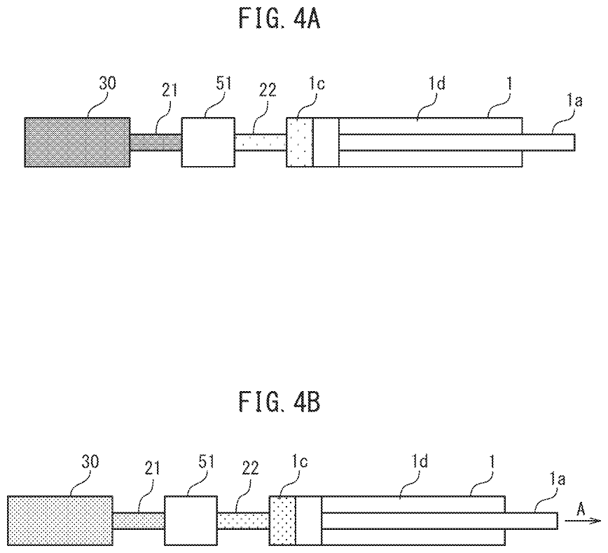

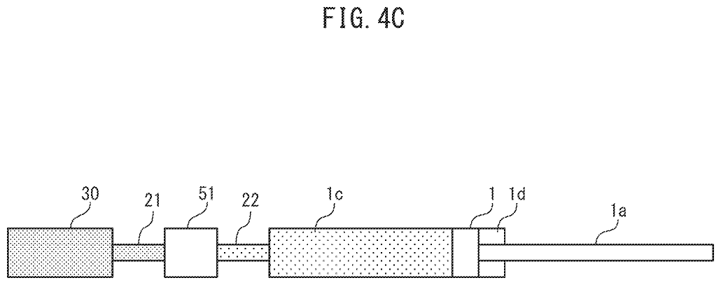

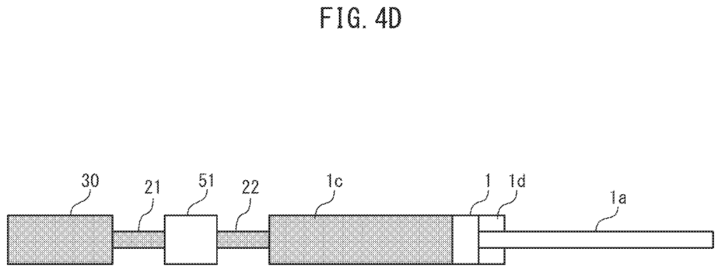

Regarding the flow rate and pressure waveform data obtained by the flow sensor 61 and the pressure sensor 62 when the air cylinders move, as an example, the case in which only a single air cylinder 1 moves will be described with reference to FIGS. 3 and 4A to 4D. Below, for ease of explanation, the direction in which the piston rod 1a (refer to FIGS. 4A to 4D) of the air cylinder advances and protrudes to the outside (the direction of arrow A in FIG. 4B) is referred to as the advancing direction, and the direction in which the piston rod 1a retracts and enters the cylinder chamber is referred to as a retracting direction.

FIG. 3 shows flow rate and pressure waveform data obtained by the flow sensor 61 and the pressure sensor 62 when the piston rod 1a of the air cylinder 1 moves from the retracted position to the forwardmost position. In FIG. 3, the horizontal axis represents time and the vertical axis represents flow rate and pressure. In FIG. 3, the solid line graph 101 shows the transition of the flow rate detected by the flow sensor 61, and the dashed line graph 102 shows the transition of the pressure detected by the pressure sensor 62.

FIGS. 4A to 4D schematically show a series of movements from the state in which the piston rod 1a of the air cylinder 1 is in the retracted position to the forwardmost position. In FIGS. 4A to 4D, the portion indicated by reference sign 30 is the portion of the air supply source side (primary side). Reference sign 21 represents the air supply path (for example, an air hose) from the air supply source side to the solenoid valve 51, and reference sign 22 represents the air supply path (for example, an air hose) from the solenoid valve 51 to the air cylinder 1. Note that the flow sensor 61 and the pressure sensor 62 are arranged in the supply path 21. Note that in FIGS. 4A to 4D, the hatching shown in the portion 30 of the air supply source side, the supply path 21, the supply path 22, and the air cylinder 1 represents the air pressure according to concentration (the higher the concentration of the hatching (darker), the greater the air pressure).

FIG. 4A is a state before the start of the driving of the cylinder, and corresponds to a state before time t0 in FIG. 3. In the state of FIG. 4A, the flow rate detected by the flow sensor 61 is zero, and the air pressure detected by the pressure sensor 62 is a high state.

At time t0, the solenoid valve 51 is driven, and the air cylinder 1 starts to move. FIG. 4B corresponds to the state at this time. In the solenoid valve 51, as the flow path from the air supply source side to the air cylinder 1 side is opened, the inflow of air into the cylinder chamber 1c of the air cylinder 1 starts. The cylinder chamber partitioned on the rear end side of the piston inside the air cylinder 1 is referred to as the cylinder chamber 1c, and the cylinder chamber partitioned on the front end side of the piston is referred to as the cylinder chamber 1d. When the inflow of air into the cylinder chamber 1c starts, the piston rod 1a starts to move forward. As shown in FIG. 3, as the inflow of air into the cylinder chamber 1c starts, the flow rate detected by the flow sensor 61 increases, and the pressure detected by the pressure sensor 62 decreases.

As shown in FIG. 3, the state in which the flow rate is increased and the pressure is decreased continues until the piston rod 1a moves to the front end. Finally, the piston rod 1a reaches the forwardmost position (FIG. 4C). In FIG. 3, time t1 is the timing when the piston rod 1a reaches the forwardmost position. As shown in FIGS. 3 and 4C, when the piston rod 1a reaches the forwardmost position, the flow rate begins to decrease and the pressure begins to increase. At time t2, the flow rate and pressure return to the states before time t0. FIG. 4D shows the state of the air cylinder 1 after time t2. In the state of FIG. 4D, the pressure in the air cylinder 1 rises and the theoretical cylinder thrust is generated.

After the driving of the air cylinder 1 has started, the controller 10 (operation state judgment unit 11) can judge that the movement of the air cylinder 1 has ended by capturing the timing of the decrease in flow rate in the flow rate waveform or the timing of the increase in pressure in the pressure waveform. Note that though the detection of the end of the movement when the piston rod 1a advances has been described, the end of the movement when the piston rod 1a returns from the front end to the rear end can be determined by the same method. In this manner, the controller 10 (operation state judgment unit 11) can understand the operation state (position of the piston rod) of the air cylinder by analyzing the waveform data of the flow sensor 61 or the pressure sensor 62. The controller 10 (solenoid valve control unit 12) can appropriately move to the execution of a subsequent operation command commanded by the host device under the condition that the end of the predetermined movement of the air cylinder is detected in this manner.

Note that though FIGS. 4C and 4D illustrate an example of the case in which the piston rod 1a is in a state in which it has reached the forwardmost position, for example, even in the case in which the position of the piston rod 1a of FIGS. 4C and 4D is a position in which an air chuck driven by the air cylinder 1 grips a workpiece, likewise, the end of movement (i.e., the completion of the movement for closing the chuck) can be judged.

According to the configuration described above, unlike the prior art, it is not necessary to arrange a sensor such as a so-called “auto switch” for each of the air cylinders in order to confirm the operation state of the air cylinders. Furthermore, even in a situation where the air chuck attempts to grip workpieces of different sizes, the end of the movement of the air cylinder (the completion of the movement for closing the chuck) can accurately be judged.

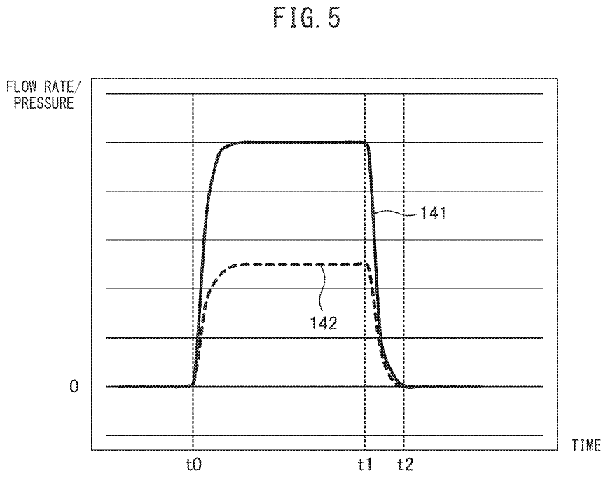

FIG. 5 shows flow rate and pressure waveform data obtained by the flow sensor 71 and the pressure sensor 72 attached in the air exhaust path 91 when the air cylinder 1 performs the series of movements shown in FIGS. 4A to 4D. In FIG. 5, the solid line graph 141 shows the transition of the flow rate detected by the flow sensor 71, and the dashed line graph 142 shows the transition of the pressure detected by the pressure sensor 72. When the air cylinder 1 performs the movement shown in FIGS. 4A to 4D, the cylinder chamber 1d is connected to the air exhaust path 91 by the movement settings for the solenoid valve 51.

Regarding the flow rate detected by the flow sensor 71, in the same manner as the case of the flow rate detected by the flow sensor 61 shown in FIG. 3, as the movement of the piston rod 1a to the front end side starts, the flow rate begins to increase (time t0). Regarding the pressure detected by the pressure sensor 72 at this time, the pressure changes from zero as the movement of the piston rod 1a to the front end side starts. While the piston rod 1a moves from the rear end to the front end, the state in which the flow rate is increased and the pressure is increased continues.

Eventually, the piston rod 1a reaches the forwardmost position (FIG. 4C). In FIG. 5, time t1 is the timing when the piston rod 1a reaches the forwardmost position. As shown in FIG. 5, when the piston rod 1a reaches the forwardmost position, the flow rate starts to decrease and the pressure also starts to decrease. Then, at time t2, the flow rate and pressure return to the states before time t0.

Even in the case in which the controller 10 (operation state judgment unit 11) uses the flow sensor 71 or the pressure sensor 72 arranged in the air exhaust path 91 in this manner, by capturing the timing of the fall of the flow rate waveform or the pressure waveform, the end of the predetermined movement of the air cylinder 1 can be determined. In other words, by using either the flow sensor 71 or the pressure sensor 72 arranged in the air exhaust path 91, the same effect as the case in which either the flow sensor 61 or the pressure sensor 62 arranged in the air supply path 81 is used can be obtained.

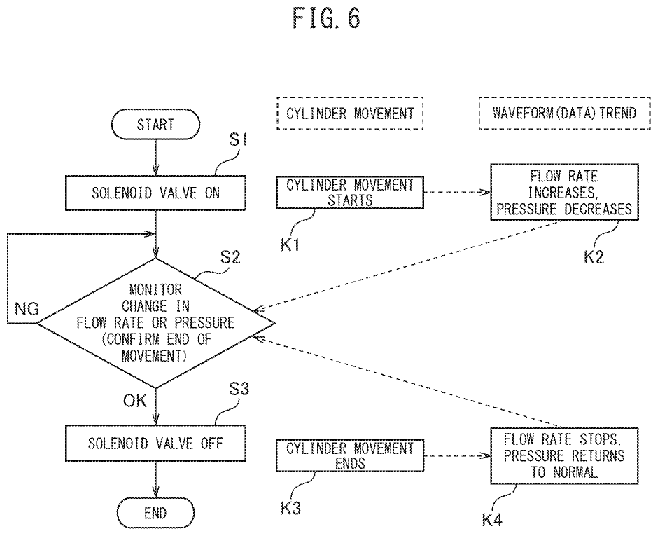

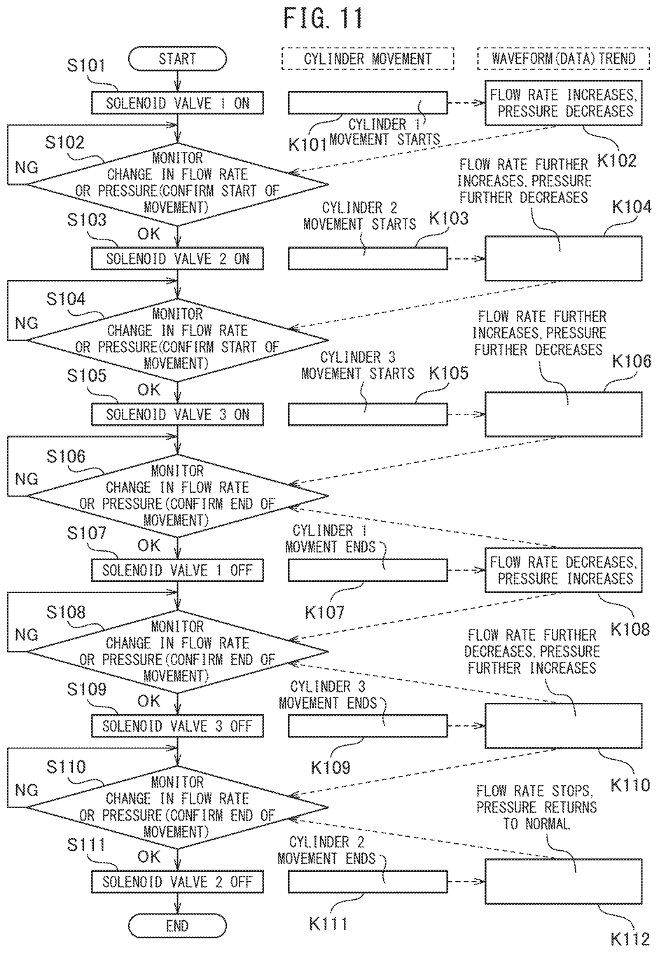

Two examples of embodiments of air cylinder control (air cylinder control methods) by the controller 10 will be described below. The first embodiment (FIG. 6) is an operation example in the case in which there is one air cylinder, and the second embodiment (FIG. 11) is an operation example in the case in which three air cylinders are controlled in parallel.

FIG. 6 is a flowchart showing movement when one air cylinder is the target of control by the controller 10. The control target is the solenoid valve 51 (air cylinder 1). The air cylinder control process of FIG. 6 (and FIG. 11) is executed under the control of the CPU of the controller 10. To facilitate understanding, FIG. 6 shows the operation state of the air cylinder and the trend of the detected waveform together with the control flow.

As shown in FIG. 6, first, the controller 10 turns on the solenoid valve 51 to open an air supply path to the air cylinder 1 (step S1). The controller 10 (operation state judgment unit 11) then monitors the waveform representing the air flow rate and the waveform representing the change in pressure obtained by the flow sensor 61 and the pressure sensor 62. As the solenoid valve 51 is turned on, the air cylinder 1 starts to move (box K1), the air flowing into the air cylinder 1 increases, and the pressure detected by the pressure sensor 62 decreases (box K2).

The piston rod 1a moves to the end of the stroke, the pressure in the air cylinder 1 rises, the theoretical cylinder thrust is generated, and when the movement of the air cylinder 1 ends (box K3), the inflow of air into the air cylinder 1 is stopped and the flow rate drops to zero, whereby the pressure returns to the original high state. In step S2, the controller 10 (operation state judgment unit 11) detects that the piston rod 1a of the air cylinder 1 has reached the stroke end (the movement of the air cylinder 1 is complete) by monitoring the waveform of the inflow amount and the waveform of the pressure. The monitoring in step S2 is continued until a change in which the flow rate drops to zero and the pressure returns to the original level is detected (S2: NG).

When the change wherein the flow rate drops to zero and the pressure returns to the original level is detected (S2: OK), the controller 10 understands that the movement of the air cylinder 1 is complete, i.e., the piston rod had reached the stroke end and the cylinder thrust has been generated, and turns off the solenoid valve 51. The solenoid valve 51 may remain on until the next movement. As a result, the process ends.

According to the first embodiment, even in a situation where workpieces of different sizes are gripped by an air chuck, the operation state of the air cylinder can be appropriately determined with a simple structure. By understanding the position of the piston rod 1a of the air cylinder 1 in this manner, the controller 10 can accurately move to the control of a subsequent operation command.

Next, the second embodiment of air cylinder control by the controller 10 will be described. In the second embodiment, the controller 10 moves three air cylinders 1 to 3 in parallel. It will be assumed that the air cylinders 1 to 3 have the same cylinder chamber inner diameters, and the total lengths (maximum strokes) thereof have the following relationship:

Air cylinder 2>Air cylinder 1>Air cylinder 3

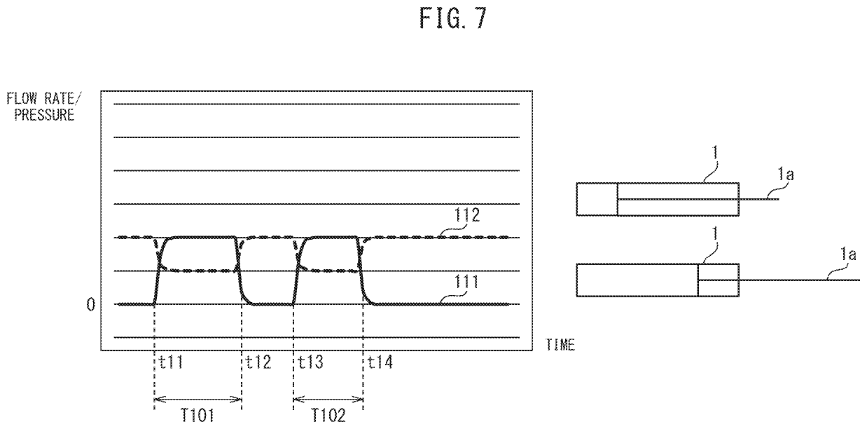

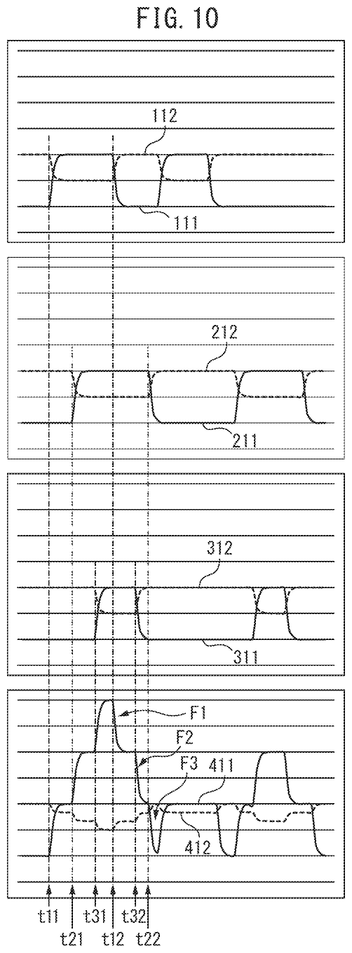

When the air cylinders 1 to 3 are moved in parallel, the flow sensor 61 and the pressure sensor 62 provide waveform data obtained by compositing the waveform data of the cases in which the air cylinders 1 to 3 are individually moved (the waveform data graph at the bottom of FIG. 10). The operation state judgment unit 11 determines the operation state of each of the air cylinders 1 to 3 by analyzing this composite waveform data. Below, the waveform data detected by the flow sensor 61 and the pressure sensor 62 when each of the air cylinders 1 to 3 is moved individually will be described with reference to FIGS. 7 to 9, and it will be described how the operation state judgment unit 11 judges the operation state of each of the air cylinders 1 to 3 from the composite waveform data. In the present embodiment, the air cylinders 1 to 3 are moved in the order of air cylinders 1 to 3.

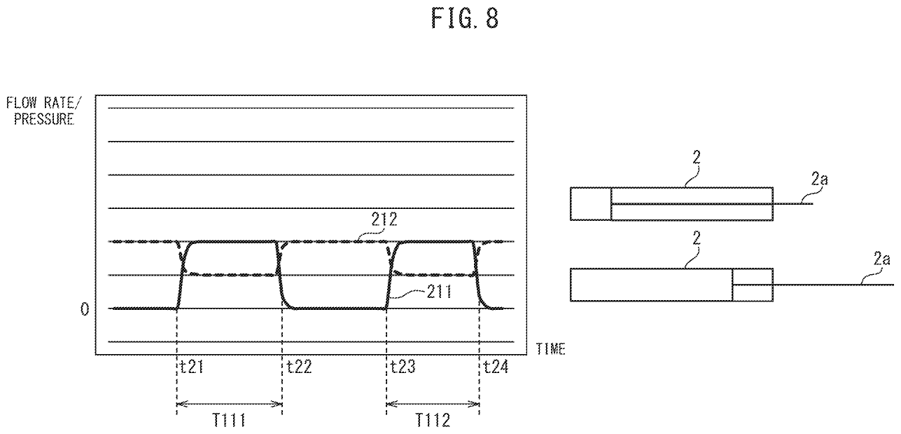

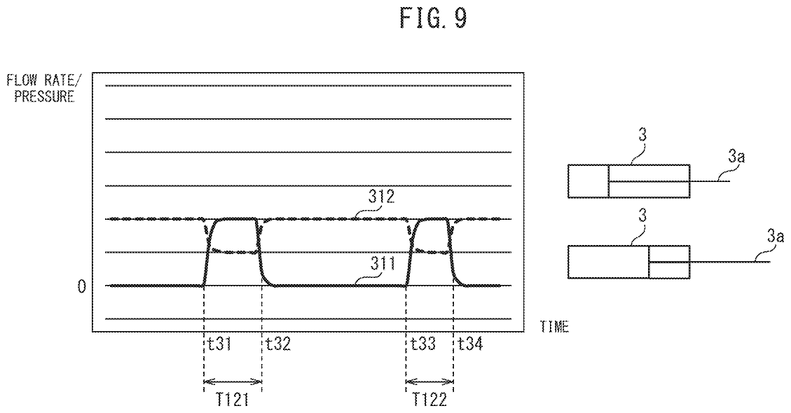

FIG. 7 shows the waveform data detected by the flow sensor 61 and the pressure sensor 62 when the air cylinder 1 independently performs a round-trip movement, FIG. 8 shows the waveform data detected by the flow sensor 61 and the pressure sensor 62 when the air cylinder 2 independently performs a round-trip movement, and FIG. 9 shows waveform data detected by the flow sensor 61 and the pressure sensor 62 when the air cylinder 3 independently performs a round-trip movement. For convenience of explanation, on the right side of each of FIGS. 7 to 9, a state in which the piston rod (1a, 2a, 3a) of the air cylinder (1, 2, 3) is in the rear end position (upper side), and a state in which the piston rod (1a, 2a, 3a) of the air cylinder (1, 2, 3) is in the forwardmost position (lower side) are shown.

In FIG. 7, graphs 111 and 112 respectively show the waveform data of the flow rate detected by the flow sensor 61 and the waveform data of the pressure detected by the pressure sensor 62 when the air cylinder 1 is moved. In FIG. 7, the movement of the air cylinder 1 is started at time t11 from the state in which the piston rod 1a is retracted to the rear end. As a result, at time t11, the flow rate begins to increase and the pressure begins to decrease.

The state in which the flow rate increases and the pressure decreases continues until the piston rod 1a reaches the front end at time t12. When the piston rod 1a reaches the front end and the forward movement of the piston rod 1a ends, the flow rate decreases, the pressure increases, and the original state is restored. The controller 10 starts driving the air cylinder 1 in the retracting direction at time t13. Along with this, the flow rate increases and the pressure begins to decrease. The state in which the flow rate increases and the pressure decreases continues until the piston rod 1a returns to the rear end position. At time t14 when the piston rod 1a returns to the rear end position, the flow rate decreases, the pressure increases, and the original state is restored.

In the waveform data of FIG. 7, when the period T101 during which the piston rod 1a moves forward from the rear end position to the forwardmost position and the period T102 during which the piston rod 1a retracts from the forwardmost position to the rear end position are compared with each other, it can be understood that the period T101 is longer. This is because the lengths of the period T101 and the period T102 correspond to the air consumption amount (total amount of flowing air), and in the case of a movement in which the piston rod 1a retracts, the amount of air consumption is smaller than that in the case of the piston rod 1a moving forward by the amount corresponding to the volume of the piston rod 1a.

In FIG. 8, graphs 211 and 212 respectively show the waveform data of the flow rate detected by the flow sensor 61 and the waveform data of the pressure detected by the pressure sensor 62 when the air cylinder 2 is moved. In the same manner as the case of FIG. 7, in FIG. 8, time t21 is the time when the piston rod 2a starts moving forward from the rear end position. Time t22 is the time when the piston rod 2a reaches the front end. Time t23 is the time when the piston rod 2a starts moving from the front end to the rear side. Time t24 is the time when the piston rod 2a reaches the rear end. As described above, since the air consumption amount when the piston rod 2a moves from the rear end to the front end is greater than the air consumption amount when the piston rod 2a moves from the front end to the rear end, the period T111 from time t21 to time t22 is longer than the period T112 from time t23 to time t24.

In FIG. 9, graphs 311 and 312 respectively show the waveform data of the flow rate detected by the flow sensor 61 and the waveform data of the pressure detected by the pressure sensor 62 when the air cylinder 3 is moved. In the same manner as the case of FIG. 7, in FIG. 9, time t31 is the time when the piston rod 3a starts moving forward from the rear end position. Time t32 is the time when the piston rod 3a reaches the front end. Time t33 is the time when the piston rod 3a starts moving from the front end to the rear side. Time t34 is the time when the piston rod 3a reaches the rear end. As described above, since the air consumption amount when the piston rod 3a moves from the rear end to the front end is greater than the air consumption amount when the piston rod 3a moves from the front end to the rear end, the period T121 from time t31 to time t32 is longer than the period T122 from time t33 to time t34.

The operation for understanding the position of each of the air cylinders 1 to 3 by waveform analysis of the composite waveform will be described below. When the air cylinders 1 to 3 perform the movements of the operation waveforms shown in FIGS. 7 to 9 in parallel, the waveform data obtained by compositing graphs 111, 211, and 311 of FIGS. 7 to 9 is obtained as output of the flow sensor 61, and the waveform obtained by compositing graphs 112, 212 and 312 is obtained as the output of the pressure sensor 62. Graph 411 of the composite waveform of the flow rate detected by the flow sensor 61 and graph 412 of the composite waveform of the pressure detected by the pressure sensor 62 are shown at the bottom of FIG. 10. Furthermore, in FIG. 10, in order to facilitate understanding of graphs 411 and 412, each graph of FIGS. 7 to 9 is reprinted aligned with graphs 411 and 412 on the time axis.

FIG. 11 is a flowchart showing control flow in the second embodiment of air cylinder control. The control flow of FIG. 11 will be described while referring to the waveform data of FIG. 10. Note that for ease of description, in each processing step in the flowchart of FIG. 11, the solenoid valves 51 to 53 will be referred to as solenoid valves 1 to 3, respectively. First, the controller 10 turns on the solenoid valve 51 at time t11 (step S101). The controller 10 monitors the waveform data detected by the flow sensor 61 and the pressure sensor 62 (step S102). The controller 10 waits for the waveform data to change and the start of the movement of the air cylinder 1 to be confirmed (step S102: NG). As the solenoid valve 51 is turned on, the air cylinder 1 begins to move (box K101), the flow rate increases, and the pressure decreases (box K102). When the start of movement is confirmed by the change of the waveform data (S102: OK), the process proceeds to the next step S103. At this stage, the end of the movement of the air cylinder does not occur.

In step S103, the controller 10 turns on the solenoid valve 52 at time t21. The controller 10 monitors the waveform data detected by the flow sensor 61 and the pressure sensor 62 (step S104). The controller 10 waits for the waveform data to change and the start of the movement of the air cylinder 1 to be confirmed (step S104: NG). As the solenoid valve 52 is turned on, the air cylinder 2 beings to move (box K103), the flow rate increases, and the pressure decreases (box K104). When the start of movement is confirmed by the change of the waveform data (S104: OK), the process proceeds to the next step S105. At this stage, the end of the movement of the air cylinder does not occur.

In step S105, the controller 10 turns on the solenoid valve 53 at time t31. The controller 10 monitors the waveform data detected by the flow sensor 61 and the pressure sensor 62 (step S106). The controller 10 waits for the end of the movement of any of the air cylinders (S106: NG). As the solenoid valve 53 is turned on, the air cylinder 3 begins to move (box K105), the flow rate increases, and the pressure decreases (box K106).

At time t12 after the start of the movement of the air cylinder 3, the movement of the air cylinder 1 ends (box K107), a change in which the flow rate decreases and the pressure increases occurs (box K108). The controller 10 (operation state judgment unit 11) captures the change in the falling edge in this case in the flow rate waveform (or the change in the rising edge in this case in the pressure waveform) (the portion indicated by reference sign F1). Specifically, the operation state judgment unit 11 captures an edge-like change in the flow rate waveform or the pressure waveform. The portion where the flow rate waveform falls or the portion where the pressure waveform rises is the timing when the movement of any of the air cylinders 1 to 3 is complete. The controller 10 specifies, for example, the air cylinder for which the movement is complete by the following operation.

The controller 10 retains a table in which the consumption amount of air when, for example, each of the air cylinders 1 to 3 is moved from the rear end position to the forwardmost position is stored. For example, the reference values retained in the table as the air consumption amount when each of the air cylinders 1 to 3 moves from the rear end position to the forwardmost position are as follows.

Air cylinder 1: V1 (liters)

Air cylinder 2: V2 (liters)

Air cylinder 3: V3 (liters)

The controller 10 acquires the flow rate when each air cylinder moves by, for example, detecting the height of the rise of the flow rate immediately after the start of movement. Alternatively, the flow rate of each air cylinder may be stored in advance by test operation. As an example, the flow rate detected for the air cylinder 1 is C1 (L/min). By multiplying the elapsed time from time t11 when the movement of the air cylinder 1 begins to the time t12 when the falling edge of the flow rate waveform is detected by the flow rate C1 (formula (1) below), the amount of air inflow for the air cylinder 1 can be determined.

(Air inflow of air cylinder 1)=C1×(elapsed time) (1)

When the air inflow amount of the air cylinder 1 determined in this manner substantially matches the air consumption amount V1 in the forward movement of the air cylinder 1 stored in advance, it can be specified that the air cylinder for which the movement is complete is the air cylinder 1. In this case, the air inflow amount from the time t11 to the time t12 is calculated in the same manner for the air cylinders 2 and 3, and comparison with V2 and V3 in the forward move of the air cylinders 2 and 3 stored in advance is also performed. The air inflow amount from the time t11 to the time t12 calculated for the air cylinders 2 and 3 does not match the air consumption amounts V2 and V3 for the air cylinders 2 and 3.

For the falling edges of the flow rate waveform detected at time t32 and time t22, the air cylinder for which the movement has ended is specified in the same manner.

When the end of the movement of the air cylinder 1 is confirmed in this manner (S106: OK), the controller 10 turns off the solenoid valve 51 (step S107). The controller 10 then monitors the waveform data detected by the flow sensor 61 and the pressure sensor 62 (step S108). The controller 10 waits for the end of the movement of any of the air cylinders (S108: NG).

At time t32, the movement of the air cylinder 3 ends (box K109), and a change in which the flow rate further decreases and the pressure further increases occurs (box K110). The controller 10 captures the change in the falling edge in this case of the flow rate waveform (or the change in the rising edge in this case of the pressure waveform) (the portion indicated by reference sign F2). The portion where the flow rate waveform falls or the portion where the pressure waveform rises is the timing when the movement of any of the air cylinders 1 to 3 has completed. The controller 10 specifies the air cylinder for which the movement has completed by the same method as the method described above for specifying the end of the movement of the air cylinder 1. Since the amount of air flowing into the air cylinder 3 between the time t31 and the time t32 is substantially the same as the air consumption amount V3 of the air cylinder 3, it can be specified that the air cylinder for which the movement has completed is the air cylinder 3.

When the end of movement of the air cylinder 3 is confirmed in this manner (S108: OK), the controller 10 turns off the solenoid valve 53 (step S109). The controller 10 then monitors the waveform data detected by the flow sensor 61 and the pressure sensor 62 (step S110). The controller 10 waits for the end of the movement of any of the air cylinders (S110: NG).

At time t22, the movement of the air cylinder 2 ends (box K111), the flow rate becomes zero, and the pressure returns to the original state (box K112). The controller 10 captures the change in the falling edge in this case of the flow rate waveform (or the change in the rising edge in this case of the pressure waveform) (the portion indicated by the symbol F3). The portion where the flow rate waveform falls or the portion where the pressure waveform rises is the timing when the movement of any of the air cylinders 1 to 3 is complete. The controller 10 specifies the air cylinder for which the movement has completed by the same method as the method described above for specifying the end of the movement of the air cylinder 1. Since the amount of air flowing into the air cylinder 2 between the time t21 and the time t22 is substantially the same as the air consumption amount V2 of the air cylinder 2, it can be specified that the air cylinder for which the move has completed is the air cylinder 2. When the end of movement of the air cylinder 2 is confirmed in this manner (S110: OK), the controller 10 turns off the solenoid valve 52 (step S111).

According to the second embodiment, by configuring the sensor (detector) arranged on the primary side (air supply source side) of the solenoid valve to detect the air flow rate and pressure, even when a plurality of air cylinders are connected to the secondary side of the solenoid valve, the operation state of each air cylinder can be appropriately determined without incurring complication of wiring that occurs when auto switches are attached to the air cylinders.

Note that though the end of movement of each air cylinder is determined using the flow sensor 61 or pressure sensor 62 arranged in the air supply path in the second embodiment described above, the end of the movement of each air cylinder can likewise be determined using the flow sensor 71 or pressure sensor 72 arranged in the air exhaust path.

The operation state judgment unit 11 of the controller 10 may be configured to detect that an abnormality has occurred in, for example, the air hose forming the air supply path 81 by analyzing the operation waveform of the flow sensor 61 and/or the pressure sensor 62. Examples of operations for detecting abnormality in the air supply path 81 will be described below. Operation example 1 and operation example 2 are examples of detecting that a defect (hole, etc.) has occurred in the air supply path 81 (air hose), and operation example 3 is an example of detecting a state in which the air supply path 81 (air hose) has become kinked, making it difficult for air to flow.

(Operation example 1) For example, the normal air consumption amount when the air cylinder 1 moves from the rear end position to the forwardmost position is defined as V1 (liter) and the operation time is defined as T101 (seconds). The operation state judgment unit 11 analyzes the waveform of the air flow rate after the actuator control system 100 has operated for some time, and using the above-mentioned formula (1) or the like, acquires the consumption amount (inflow amount) of air and operation time when the air cylinder 1 moves from the rear end position to the forwardmost position. Further, when the consumption amount of air acquired in this manner exceeds V1 (liter) or when the operation time exceeds T101 (seconds), the operation state judgment unit 11 judges that a defect has occurred in the air supply path 81 since the air consumption amount has increased or air inflow takes more time as compared to normal operation.

(Operation example 2) It is considered that when a defect has occurred in the air supply path 81, the rate of change of the rising edge and falling edge of the pressure fluctuation waveform detected by the pressure sensor 62 becomes blunt. The operation state judgment unit 11 can judge that a defect has occurred in the air supply path 81 when the rise or rate of change of the rising edge of the pressure waveform detected by the pressure sensor 62 is slower than in the normal state.

(Operation example 3) It will be assumed that the air hose forming the air supply path 81 is kinked, making it difficult for air to flow. In this case, since the air flow rate decreases as a whole, the air consumption amount is equal to the normal consumption amount V1, but the operation time is longer than the normal operation time T101. Thus, when such a situation occurs, the operation state judgment unit 11 can judge that the air hose is kinked, whereby air inflow is difficult.

According to the present embodiment as described above, by configuring the sensor (detector) arranged on the primary side (air supply source side) of the solenoid valve to detect the air flow rate and pressure, even when a plurality of air cylinders are connected to the solenoid valve, the operation state (position) of each air cylinder can properly be determined without causing complication of wiring, as in the case in which auto switches are used. Furthermore, even in a situation where workpieces of different sizes are gripped by an air chuck, the operation states of the air cylinders can be appropriately determined with a simple structure.

Specifically, according to the embodiments described above, complication of wiring and the like that may occur when an auto switch is used can be avoided.

Though the present invention has been described above using typical embodiments, a person skilled in the art could understand that modification and various other changes, omissions, and additions can be made to the embodiments described above without deviation from the scope of the present invention.

In the embodiments described above, as described in, for example, the flowchart of FIG. 6, the controller 10 detects the falling edge of the time fluctuation waveform of the flow rate, determines that the movement of the air cylinder has ended, and then transmits a subsequent operation command. From the viewpoint of shortening the cycle time in the control of the air cylinders, the controller 10 (solenoid valve control unit) may determine the total amount of air flowing into the air cylinder (or the total amount of air discharged from the air cylinder) after the predetermined movement of the air cylinder has started by analyzing the flow rate waveform, and may transmit a subsequent operation command to the solenoid valve on the condition that the total amount of the air has reached a predetermined ratio (for example, 90%) with respect to a reference value (for example, V1 described above) stored in advance as a value representing the consumption amount of the air consumed by the air cylinder when the predetermined movement is performed.

The functional blocks of the controller 10 shown in FIG. 2 may be realized by the CPU of the controller 10 executing various software stored in the storage device, or alternatively, may be realized by a hardware-based configuration such as an ASIC (application specific IC).

The program for executing the air cylinder control process of the embodiments described above can be recorded on various computer-readable recording media (for example, semiconductor memory such as ROM, EEPROM, and flash memory, magnetic recording medium, or an optical disk such as a CD-ROM or DVD-ROM).

### DESCRIPTION OF REFERENCE SIGNS

1, 2, 3 air cylinder
1a, 2a, 3a piston rod
5 solenoid valve
10 controller
11 operation state judgment unit
12 solenoid valve control unit
51, 52, 53 solenoid valve
61, 71 flow sensor
62, 72 pressure sensor
81 air supply path
91 air exhaust path
100 actuator control system

1. A pneumatic actuator controller, comprising:
a detector which is arranged in an air supply path from an air supply source to a solenoid valve or an air exhaust path from the solenoid valve and which detects a flow rate or pressure of air in the air supply path or a flow rate or pressure of air in the air exhaust path, and
an operation state judgment unit configured to judge an operation state of a pneumatic actuator connected to the solenoid valve based on data indicating change in the flow rate or pressure of air in the air supply path or the flow rate or pressure of the air in the air exhaust path detected by the detector.

2. The pneumatic actuator controller according to claim 1, further comprising a solenoid valve control unit configured to transmit an operation command to the solenoid valve based on the operation state judged by the operation state judgment unit.

3. The pneumatic actuator controller according to claim 2, wherein the detector detects the flow rate of the air in the air supply path or the air exhaust path, and
the operation state judgment unit judges that a predetermined operation by the pneumatic actuator has ended at a timing of a fall of a time fluctuation waveform of the flow rate after the solenoid valve control unit has sent the operation command.

4. The pneumatic actuator controller according to claim 2, wherein the detector detects the pressure of the air in the air supply path, and
the operation state judgment unit judges that a predetermined operation by the pneumatic actuator has ended at a timing of a rise of a time fluctuation waveform of the pressure after the solenoid valve control unit has sent the operation command.

5. The pneumatic actuator controller according to claim 2, wherein the detector detects the pressure of the air in the air exhaust path, and
the operation state judgment unit judges that a predetermined operation by the pneumatic actuator has ended at a timing of a fall of a time fluctuation waveform of the pressure after the solenoid valve control unit has sent the operation command.

6. The pneumatic actuator controller according to claim 3, wherein the solenoid valve control unit transmits a subsequent operation command to the pneumatic actuator on a condition of completion of the predetermined operation of the pneumatic actuator.

7. The pneumatic actuator controller according to claim 2, wherein the detector detects the flow rate of the air in the air supply path or the air exhaust path, and
the solenoid valve control unit transmits a subsequent operation command to the pneumatic actuator on a condition that a total amount of air flowing into the pneumatic actuator or exhausted from the pneumatic actuator after the start of the predetermined operation of the pneumatic actuator determined from the flow rate detected by the detector has reached a predetermined ratio relative to a reference value stored in advance as a value indicating an amount of air consumed by the pneumatic actuator when the predetermined operation is performed.

8. The pneumatic actuator controller according to claim 2, wherein a plurality of pneumatic actuators are connected to the solenoid valve,
the solenoid valve is configured so as to be capable of controlling supply of air from the air supply path to each of the plurality of pneumatic actuators and introduction of exhaust from each of the plurality of pneumatic actuators into the air exhaust path, and
the operation state judgment unit judges the operation state of each of the plurality of actuators based on data indicating a change in the flow rate or pressure of the air in the air supply path or the flow rate or pressure of the air in the air exhaust path detected by the detector when the plurality of pneumatic actuators operate in parallel.

9. The pneumatic actuator controller according to claim 8, wherein the operation state judgment unit judges that the predetermined operation of any of the plurality of pneumatic actuators has ended at a timing of a change of an edge shape of a time fluctuation waveform of the flow rate or the pressure after the operation by any of the plurality of pneumatic actuators has started, and
the operation state judgment unit specifies the pneumatic actuator, among the plurality of pneumatic actuators, which has completed the predetermined operation, based on a reference value stored in advance as a value indicating an amount of air consumed by each of the plurality of pneumatic actuators when the predetermined operation is performed and a flow rate of air that has flowed into or been exhausted from each of the plurality of pneumatic actuators from the start of the predetermined operation of each of the plurality of the pneumatic actuators to the timing of the change of the edge-shape.

10. The pneumatic actuator controller according to claim 1, wherein the detector detects the flow rate of air in the air supply path, and
the operation state judgment unit determines an air consumption amount or operation time when the pneumatic actuator performs a predetermined operation based on data representing change in the flow rate detected by the detector, and judges that an abnormality has occurred in the air supply path:
(1) when the determined air consumption exceeds normal air consumption when the pneumatic actuator performs the predetermined operation, or
(2) when the determined operation time exceeds normal operation time when the pneumatic actuator performs the predetermined operation.

11. The pneumatic actuator controller according to claim 1, wherein the detector detects the pressure of the air in the air supply path, and
the operation state judgment unit judges that an abnormality has occurred in the air supply path when a rate of change in an edge portion of a time fluctuation waveform of the pressure becomes slower than the rate of change in a normal state.

12. The pneumatic actuator controller according to claim 1, wherein the detector detects the flow rate and the pressure of the air in the air supply path,
the operation state judgment unit determines an air consumption amount or operation time when the pneumatic actuator performs a predetermined operation based on data representing change in the flow rate detected by the detector, and
judges that an abnormality has occurred in the air supply path when the determined air consumption amount is equal to a normal air consumption amount when the pneumatic actuator performs the predetermined operation and the determined operation time exceeds a normal operation time when the pneumatic actuator performs the predetermined operation.
